(19) United States
(12) Patent Application Publication
(10) Pub. No.: US 2024/0200404 A1
(43) Pub. Date: Jun. 20, 2024

(54) Screening arrangement comprising a suspension assembly, and a method of mounting the screening arrangement

(71) Applicant: VKR Holding A/S, Hørsholm (DK)

(72) Inventor: Martin Birkkjær BOYSEN, Esbjerg (DK)

(21) Appl. No.: 18/544,124

(22) Filed: Dec. 18, 2023

(30) Foreign Application Priority Data
Dec. 19, 2022 (DK) PA 2022 70631
Dec. 19, 2022 (DK) PA 2022 70632
Dec. 19, 2022 (DK) PA 2022 70633
Jun. 20, 2023 (DK) PA 2023 70315

(51) Int. Cl. E06B 9/70; E06B 9/42; E06B 9/58

(52) U.S. Cl. CPC E06B 9/70; E06B 9/42; E06B 9/58; E06B 2009/2476

(57) ABSTRACT

The screening arrangement (10) comprises a screening body (15), two side rails (12), a bottom element (14) connected to a bottom portion of the screening body (15) and being configured to be longitudinally positionable in a longitudinal direction (L) between a non-screening position of the screening body (15) and a screening position by means of electric drive means (22) operably connecting the bottom element (14) and the side rails (12, 13), the screening body (15) defining a screening plane (SP) in said screening position. The electric drive means (22) comprise operating means including first transmission means including a cogwheel (144) at each longitudinal end portion of the bottom element (14) and second transmission means including a rack (124) arranged in each of the side rails (12, 13). A suspension assembly (40) provided at each end of the bottom element (14) comprises an inner part (41) provided with said first transmission means, and an outer part (42). The inner part (41) and the outer part (42) are movable relative to each other to allow the cogwheel (144) of the first transmission means to assume an engaged condition in which the cogwheel (144) is in engagement with the rack (124) of the second transmission means and a disengaged condition in which the cogwheel (144) is disengaged from the rack (124). The suspension assembly (40) is configured such that the cogwheel (144) of the first transmission means is allowed to perform a substantially part-circular movement about a centre of rotation (CR) located on said screening plane (SP) during movement of the inner part (41) relative to the outer part (42) when moving from the engaged condition to the disengaged condition and vice versa.

### TECHNICAL FIELD

The present invention relates to a screening arrangement for a window, preferably a roof window, said window comprising a frame with a top member, a bottom member and two mutually parallel side members, according to the preamble of claim 1. The invention furthermore relates to a method of mounting the screening arrangement.

### BACKGROUND ART

Screening arrangements of this kind are known in the art. Applicant's International publication WO 02/068786 A1 and European patents No. 2738342, 2738343 and 2738344 show and describe screening arrangements of the kind mentioned in the introduction. While the challenges in installing such screening arrangements are to some extent alleviated, there is still room for improvement.

### SUMMARY OF INVENTION

With this background, it is therefore an object of the invention to provide a screening arrangement by which the mounting is made easier while at the same time ensuring the integrity of in particular the screening body.

In a first aspect, this and further objects are met by a screening arrangement of the kind mentioned in the introduction, which is furthermore characterised in that the suspension assembly is configured such that the cogwheel of the first transmission means is allowed to perform a substantially part-circular movement about a centre of rotation located on said screening plane during movement of the inner part relative to the outer part when moving from the engaged condition to the disengaged condition and vice versa.

By allowing the cogwheel of the first transmission device to rotate about a centre of rotation located on the screening plane itself, a controlled movement of the bottom element and of the suspension assembly at either end is carried out. Thus, during installation of the screening arrangement, unintentional folding or creasing of the screening body is avoided.

In a presently preferred embodiment, the bottom portion of the screening body is connected to the bottom element at or near a top edge of a front of the bottom element, and the centre of rotation is located at a distance from the top edge of the front of the bottom element as seen in the longitudinal direction. While the centre of rotation could in principle be located at any position on the screening plane, it is advantageous to have some distance from the transmission means such that rotation even through a limited angle provides a sufficient lift of the cogwheel out of engagement with the rack. In turn, this makes it possible to protect the screening body to an even larger extent due to the limited rotation.

In another embodiment, which provides for a mechanically simple and reliable connection, the inner part and the outer part of the suspension assembly comprise curved engagement means defining a radius of curvature allowing the cogwheel of the first transmission means to perform the substantially part-circular movement about the centre of rotation.

In an embodiment which allows for modular manufacture and a compact configuration, the bottom element comprises a main portion composed by a set of profiles defining a cross-sectional shape of the bottom element, and two end portions surrounding respective longitudinal ends of the main portion of the bottom element.

In a further development of this embodiment, the inner part of the suspension assembly comprises a substantially plane base portion and a front portion which together match the cross-sectional shape of the main portion of the bottom element.

In a further embodiment, which is advantageous in manufacture, installation and use, the outer part of the suspension assembly comprises a base portion and a slide portion interacting with a track in the associated side rail. Separating the functionality of coupling to the side rails in such a slide portion allows safe engagement throughout handling.

In a presently preferred embodiment, the curved engagement means of the suspension assembly are provided by at least one curved guide portion on the inner part, optionally in a base portion of the inner part, to interact with at least one corresponding protrusion on the outer part, optionally on a base portion of the outer part. Thus, the inner part is so to say slid along the protrusion by its associated curved guide portion to perform the controlled rotation.

In a further development of this embodiment, the inner part of the suspension assembly comprises at least two curved guide portions at a mutual distance from each other and at least two protrusions, preferably at least three curved guide portions and three protrusions. This improves the movement control even further.

To ensure that the screening arrangement is in an operating position by default, it is preferred that the suspension assembly is biased towards the engaged condition in which the inner part and the outer part overlap each other, preferably by means of a spring acting on the inner part.

In one embodiment, one or more of said protrusions comprises a head configured to slide on a face of the inner part facing away from the outer part during the movement of the inner part relative to the outer part. This embodiment ensures improved integrity of the screening arrangement since it is ensured that the outer parts are safely retained on the inner parts.

In a presently preferred embodiment, the inner part and the outer part of the suspension assembly are able to assume two distinct positions relative to each other in said disengaged condition. This provides for the possibility to utilise one of the distinct position as a supply condition, while the other position is obtainable during use. The provision of a well-defined supply condition has the advantage that the installation is improved even further.

In a second aspect, a method of mounting a screening arrangement is devised.

Other presently preferred embodiments and further advantages will be apparent from the subsequent detailed description and drawings.

A feature described in relation to one of the aspects may also be incorporated in the other aspect, and the advantage of the feature is applicable to all aspects in which it is incorporated.

### BRIEF DESCRIPTION OF DRAWINGS

In the following description embodiments of the invention will be described with reference to the drawings, in which

FIG. 1 is a plan view of a screening arrangement in an embodiment of the invention, mounted in a frame of a window;

FIG. 2 is a partial view, on a larger scale, of the upper right-hand corner of the screening arrangement and window of FIG. 1;

FIG. 3 is a partial perspective view of a position indicator mounted on a side rail of the screening arrangement in the embodiment of FIGS. 1 and 2;

FIG. 4 is a perspective view of a screening arrangement in an embodiment of the invention, with the screening body in a screening position;

FIG. 5 is a perspective view of the screening arrangement of FIG. 4, seen from a back side;

FIG. 6 is a partial perspective view, on a larger scale, of a bottom element and a side rail of the screening arrangement of FIG. 5;

FIG. 7 is a partial perspective view, on a larger scale of the bottom element and the other side rail of the screening arrangement of FIG. 5;

FIG. 8 is a partial perspective view of a screening arrangement including an end piece in an embodiment of the invention;

FIG. 9 is a partial side view of a top casing, bottom element and a side rail of a screening arrangement in an embodiment of the invention;

FIG. 10 is a cross-sectional view of a top casing and a bottom element of a screening arrangement in an embodiment of the invention;

FIG. 11 is a partial perspective view of a bottom element of a screening arrangement in an embodiment of the invention;

FIG. 12 is a partial side view of the screening arrangement in the embodiment of FIG. 11;

FIG. 13 is a view corresponding to FIG. 12, in which an outer part has been removed to show an inner part of a suspension assembly of the screening arrangement;

FIG. 14 is a partial perspective view of the screening arrangement of FIGS. 11 to 13;

FIG. 15 is an exploded view of the screening arrangement of FIG. 14, with the outer part shown removed from the inner part;

FIG. 16 is a partial side view of an inner part of a suspension assembly and a side rail of a screening arrangement in an embodiment of the invention;

FIG. 17 is a view corresponding to FIG. 16, with the suspension assembly in a disengaged condition;

FIG. 18 is a partial side view of an outer part of a suspension assembly and a side rail of a screening arrangement in an embodiment of the invention, with the suspension assembly in an engaged condition;

FIG. 19 is view corresponding to FIG. 18, with the suspension assembly in a disengaged condition;

FIG. 20 is a side view of an inner part and an outer part of a suspension assembly of the screening arrangement in an embodiment of the invention;

FIGS. 21 to 23 are side views of the inner and outer parts of FIG. 20 shown in three successive relative positions; and

FIG. 24 is a partial side view of a screening arrangement in an embodiment of the invention.

### DESCRIPTION OF EMBODIMENTS

In the following detailed description, preferred embodiments of the present invention will be described. However, it is to be understood that features of the different embodiments are exchangeable between the embodiments and may be combined in different ways, unless anything else is specifically indicated. It may also be noted that, for the sake of clarity, the dimensions of certain components illustrated in the drawings may differ from the corresponding dimensions in real-life implementations.

It is noted that terms such as “up”, “down”, “left-hand”, “right-hand”, “exterior”, “interior”, “outer”, “inner” are relative and refers to the viewpoint in question.

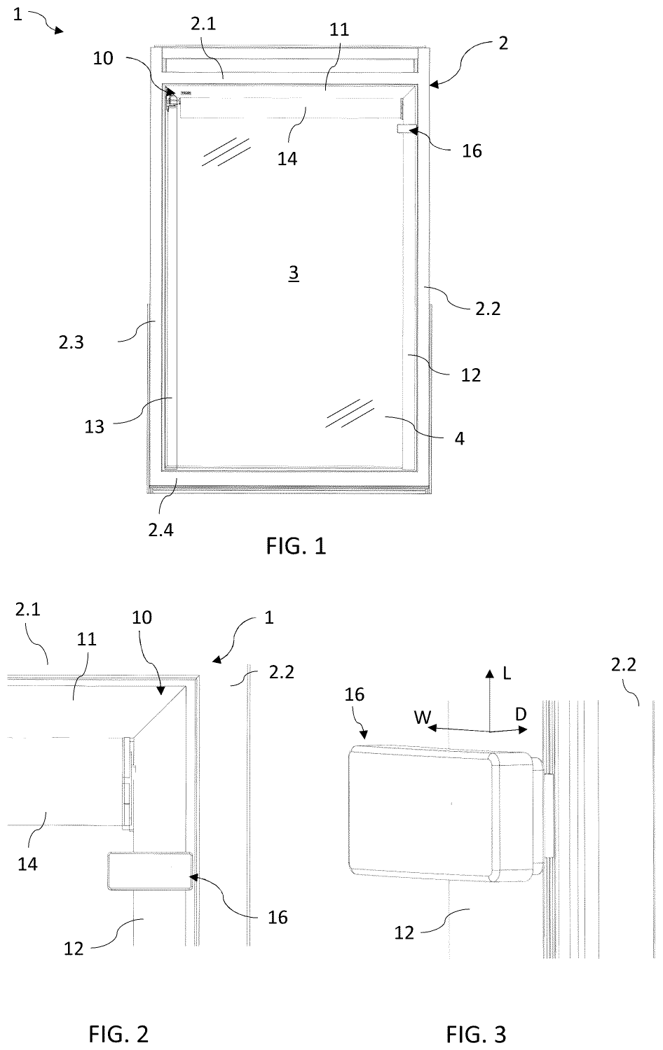

Referring initially to FIGS. 1 to 3, an embodiment of a screening arrangement generally designated 10 is shown, mounted in a frame 2 representing a window. In the shown configuration, the frame 2 constitutes a pane-carrying sash of a roof window 1 and may be pivotable about a centre axis, or top-hung, relative to a stationary frame (not shown) of the roof window 1. The frame 2 may likewise be a stationary frame, which in a mounted position of the window lines an aperture in a building. It is noted that the term “frame” is to be understood as incorporating any substantially rectangular structure positioned in any opening in a building, whether in a wall or the roof, and surrounding an opening 3 to be screened. The screening arrangement 10 may thus be utilised in connection with e.g. windows having a frame only, windows having a sash and a frame, or in doors. In the present context, the screening arrangement 10 will be described as an internal, or an interior, screening arrangement mounted on the interior side of a roof window, i.e., the side facing an inside room of a building, in other words an interior roof window screening arrangement 10.

The frame 2 has a top member 2.1, two mutually parallel side members 2.2, 2.3, and a bottom member 2.4, surrounding the opening 3 to be screened, covered by a suitable panel element such as insulating glazing in the form of a pane 4.

The screening arrangement 10 comprises a screening device including a screening body 15 having two side edges and a top and bottom portion, to be shown and described below.

Two side rails 12, 13 are provided in the screening device, each defining a longitudinal direction L, a width direction W and a depth direction D as shown in FIG. 3. Referring also to figures of other embodiments described below, each side rail 12 comprises a first flange 121, a second flange 122 and a leg 123. The leg 123 extends at substantially right angles to the first and second flanges 121, 122 and serves to fasten the side rail 12 to the frame 2.

The screening device of the screening arrangement 10 further comprises a top casing 11 located at the top member 2.1 of the frame. A top portion 151 of the screening body 15 is typically fastened to a winding, folding, or rotating structure such as a spring-biased roller bar in a roller blind accommodated in the top casing 11, which also accommodates the top portion of the screening body 15 and connected to an upper end of the side rails.

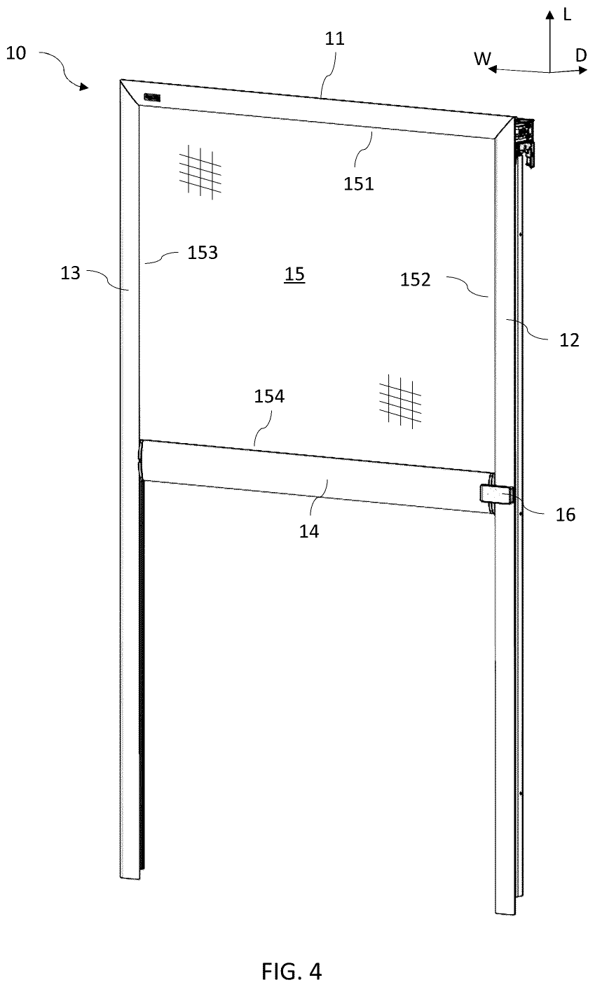

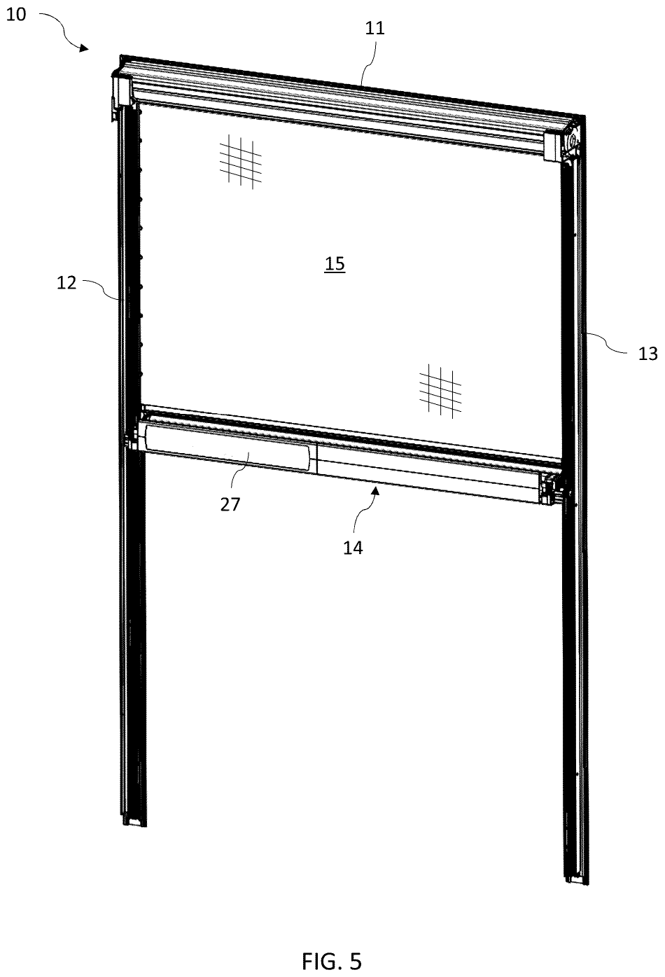

Referring now also to FIG. 4 and FIG. 5, the whole screening device of the screening arrangement 10 in an embodiment of the invention is shown in a front and rear view. A bottom element 14 of the screening device of the screening arrangement 10 is connected to a bottom portion 154 of the screening body 15 and configured to be longitudinally positionable in the longitudinal direction L between a non-screening position of the screening body 15, cf. FIG. 1, and a screening position as shown in FIGS. 4 and 5.

In the embodiments of the invention, the movement is provided by means of electric drive means operably connecting the bottom element 14 and the side rails 12, 13 as will be described in some detail below.

The screening body 15 defines a screening plane SP (cf. FIG. 15) in the screening position substantially parallel to a plane defined by the longitudinal direction L and the width direction W. Side edges 152, 153, or elements at the side edges, of the screening body 15 are guided in respective side rails 12, 13.

It is noted that the terms top portion and bottom portion of the screening body 15 denote the position the respective portions assume in the mounted condition of the screening arrangement 10. Other mounting positions are conceivable.

The screening body 15 is typically made from cloth or fabric, which may be flexible to allow rolling up, but may also be pleated. However, other screening devices having other kinds of screening bodies are conceivable for use in the screening arrangement of the invention. Hence, it is noted that as used herein the term “screening body” is intended to encompass all feasible types of screening bodies, examples being roller blinds, lamella blinds, curtains, awnings, roller shutters, and shades.

The screening arrangement comprises a position indicator 16 slidably positionable along one or the other of the side rails 12, 13 for manually indicating a desired longitudinal position of the bottom element 14. In the following, the position indicator 16 will be described as being positioned on the right-hand side rail 12. The longitudinal position of said position indicator 16 is manually adjustable by physical movement of the position indicator to an arbitrary longitudinal position along the side rail 12. The bottom element 14 is provided with a notch 141 by which the position indicator 16 is able to be brought into releasable positive engagement.

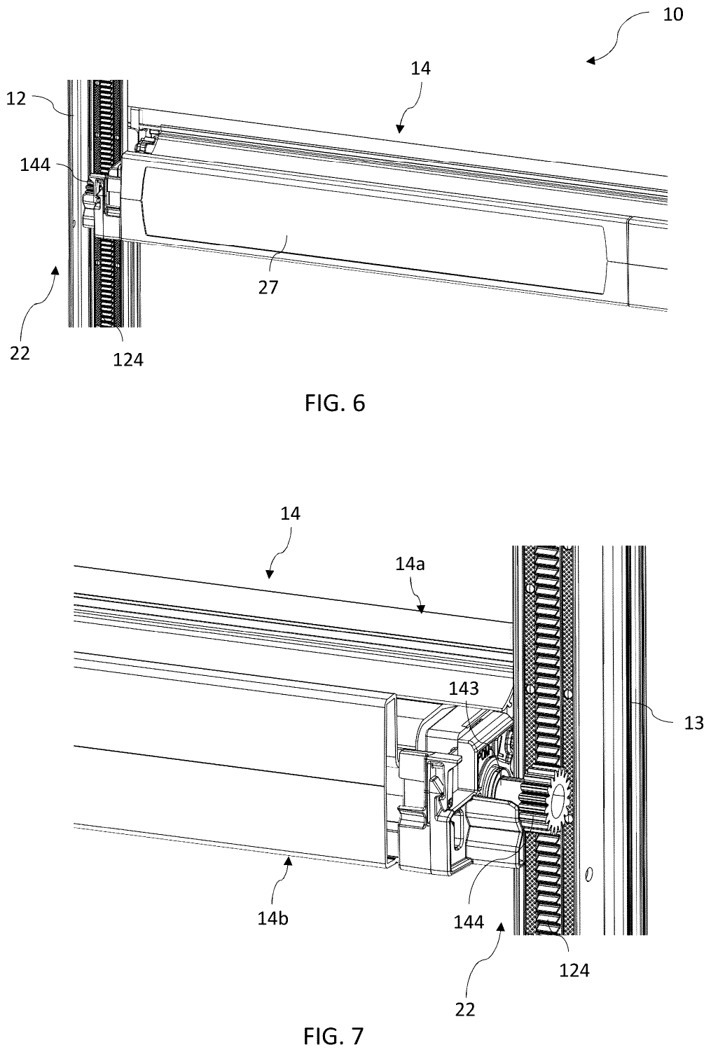

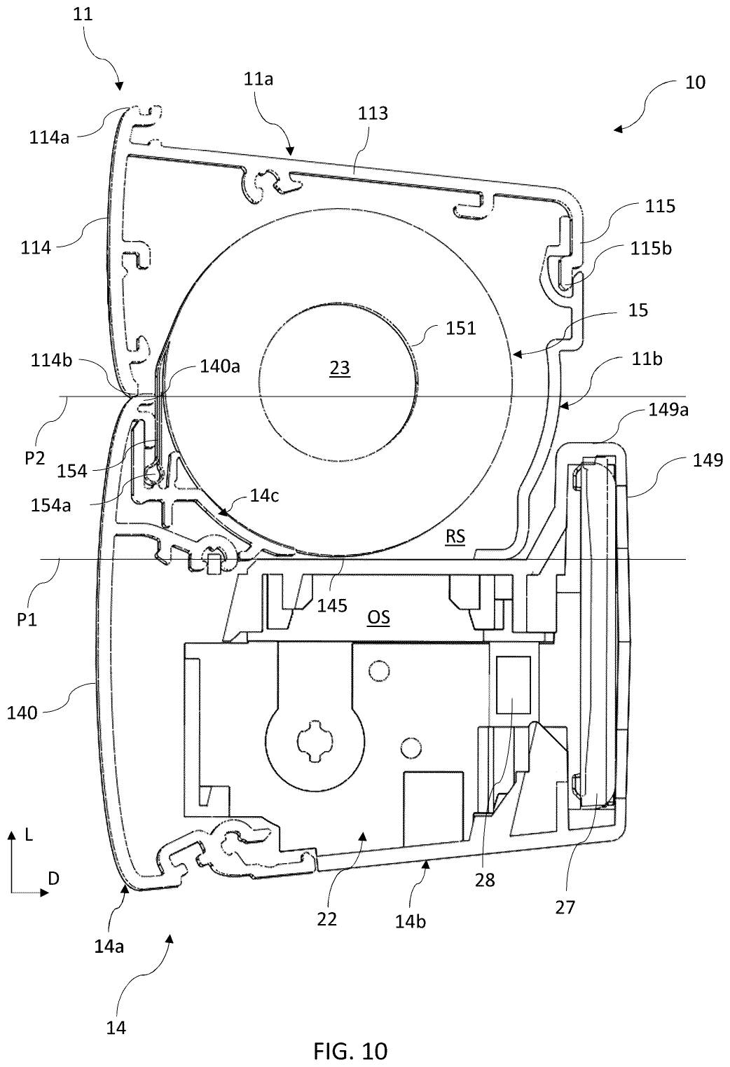

In the embodiments shown, the screening device is electrically operated by means of electric drive means 22 of the screening arrangement 10, to be described in further detail below. In order for the electric drive means to work, energy is required. The energy may be collected from solar panels 27 as shown in FIGS. 5 and 6 and/or mains power supply, preferably supplemented by battery means 28 (shown in FIG. 10). For the solar panels to be able to be exposed to as much sunlight as possible it is preferred to have the solar panels 27 placed on the side of the bottom element 14 facing the window glazing, assuming the screening arrangement 10 is mounted on the inside side of a window. The solar panel generally extends in a plane parallel to the screening plane SP.

Further details shown in FIGS. 6 and 7 include operating means of the electric drive means 22. The operating means comprise a cogwheel 144 for interacting with a rack 124 on each side rail 12, 13 to translate rotational movement of the cogwheel 144 to translational movement of the bottom element 14. One cogwheel 144 is present at each longitudinal end portion of the bottom element 14, as shown on a rotatable shaft 143, and the cogwheels 144 constitute first transmission means to interact with second transmission means including the two racks 124 arranged in the respective side rails 12, 13 to facilitate the translational movement of the bottom element 14 along the longitudinal direction L.

By the term “at each longitudinal end portion” etc. is to be understood throughout the description and claims that the cogwheels are provided at, near, or proximate such end portions of the bottom element. This does not exclude that parts, portions or components of the bottom element may be present beyond the position of the cogwheel, as seen the longitudinal direction of the bottom element, or width direction W of the screening arrangement 10. By near or proximate, it is meant that the cogwheels are disposed or oriented so as to engage a corresponding rack to move the screening body between a screening position or state and a non-screening position or state when such operation is desired, i.e., moving between a screening position or state and a non-screening position or state. Typical ranges for any distance between the cogwheels and the respective physical end portion of the bottom element are 0 to 20 mm, in particular 5 to 10 mm.

By the term “in the side rail” etc. is to be understood that the rack is located in conjunction with, associated with, or on the side rail in question. The rack may be formed as a separate part connected to the side rail, be formed integrally with, or constitute a portion of the side rail.

Depending on whether the screening arrangement is powered solely by solar panels 27, possibly supplemented by battery means 28 as shown in the embodiment of FIG. 10, or mains power, end pieces of the top casing 11 interact with suitable mounting brackets (not shown) provided for instance on the side members 2.2, 2.3 of the frame 2. Such mounting brackets are well-known in the art and are typically pre-mounted in commercially available roof windows, comprising a standard version or a version including electric contacts as described in Applicant's European patents Nos. 2002079 and 3203008.

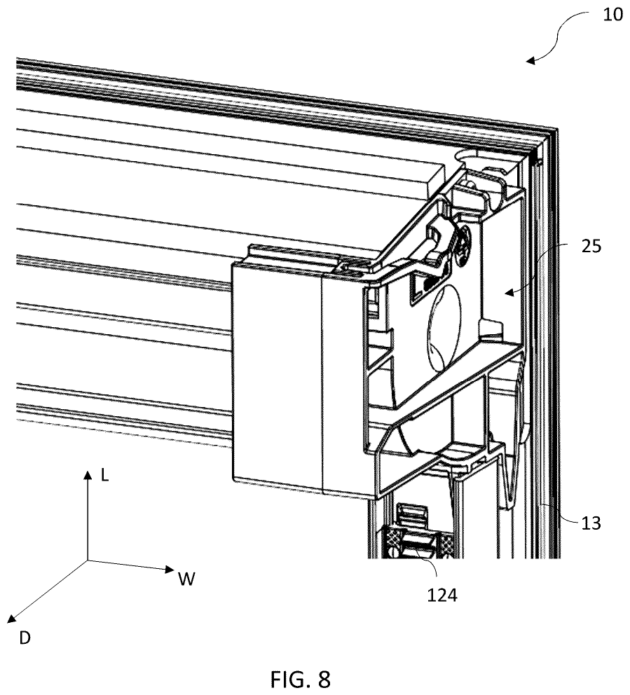

In that regard, the embodiment shown in FIG. 8 provides a detailed rear view of the top casing 11 as shown in FIG. 5, in which an end piece 25 is shown to interact with a standard version mounting bracket. This is made possible, since the solar panels 27, possibly supplemented by battery means, provide the power required to operate the screening arrangement 10.

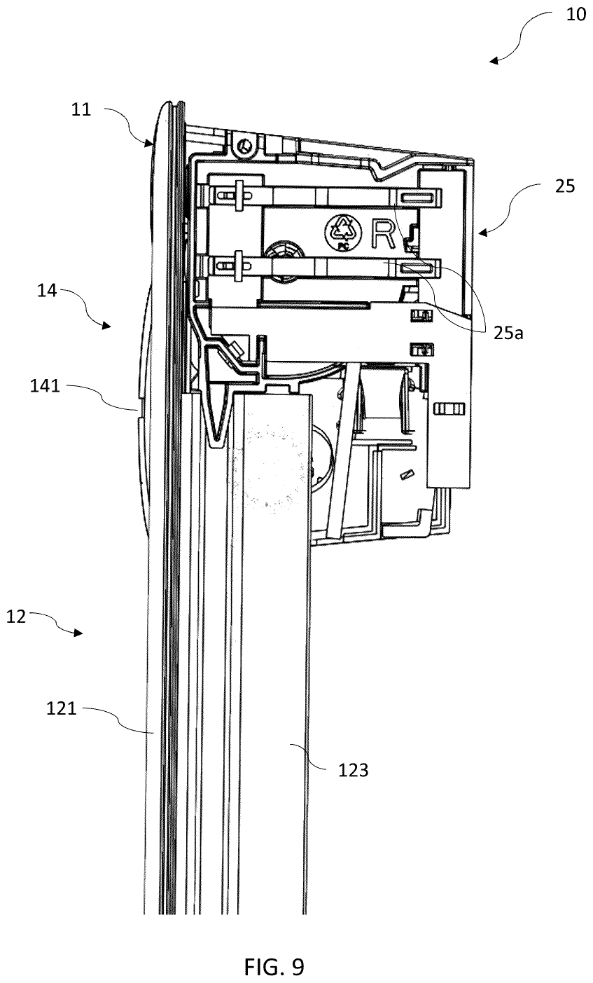

FIG. 9 shows a detailed side view of the top casing 11 of an alternative embodiment in which the end piece 25 is provided with electric terminals 25a for interaction with a mounting bracket including electric contacts, for instance of the kind mentioned in the above.

Regarding the configuration of the top casing 11 and the interaction with the bottom element 14, reference is made to FIG. 10, in which it is seen how the bottom portion 154 of the screening body 15 in the embodiment shown is connected to the bottom element 14 at or near a top edge 140a of a front 140 of the bottom element 14. In order to provide connection of the screening body 15 and the bottom element 14, the bottom portion 154 is folded around a locking wire 154a; the package thus obtained is accommodated in the bottom element 14. In addition to the front 140, the bottom element 14 comprises an upwards facing surface 145 and a back portion 149 with a top edge 149a. The back portion 149 accommodates the solar panel 27 on an exterior side. A receiving space RS is delimited in the longitudinal direction L by a first plane P1 substantially parallel with a plane spanned by the width direction W and the depth direction D, and a second plane P2 parallel with the first plane P1 and located at a higher level than the first plane P1.

The bottom element 14 in FIG. 10 is in a position corresponding to the non-screening position of the screening arrangement 10, as the bottom element 14 abuts or is close to a bottom edge 114b opposite a top edge 114a of a front rail 114 of the top casing 11 and a portion of the screening body 15 is rolled up on a roller shaft 23, for instance such that a majority of the rolled-up screening body 15 is accommodated in the receiving space RS. Furthermore, first, second and third profiles 14a, 14b, and 14c are shown in FIG. 10. The profiles 14a, 14b, 14c form an outer shell of the bottom element 14 extending over the whole width of the bottom element. The second profile 14b comprises protrusions to support the solar panel 27 and an opening to allow the solar panel to be exposed to light. The first and third profile 14a, 14c are interconnected by overlapping portions of the profiles. As it also appears from FIG. 10, the bottom element 14 comprises an operating space OS to accommodate operating means of the electric drive means. The operating space OS also accommodates the battery means 28. Finally, the top casing 11 comprises a cover top portion 113 and a cover back portion 115 with a bottom edge 115b. The top casing 11 is in the embodiment shown composed by a set of profiles 11a, 11b defining a cross-sectional shape of the top casing 11. Here, the first profile 11a comprises the front rail 114, the cover top portion 113 and the cover back portion 115, and the second profile 11b comprises an additional back element adjoining the cover back portion 115. Also, the bottom element 14 of the embodiment shown comprises a main portion composed by a set of profiles, for instance the profiles 14a, 14b, 14c shown in FIG. 10, defining a cross-sectional shape of the bottom element 14. The third profile 14c is curved, forming a hollow to accommodate the screening body 15 in the non-screening position. The bottom element 14 further comprises two end portions surrounding respective longitudinal ends of the main portion of the bottom element 14, closing the openings created by the set of profiles.

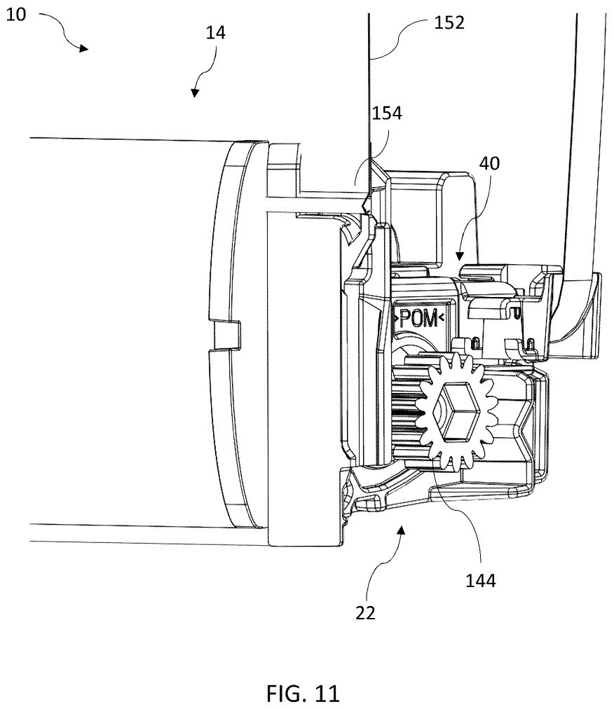

Turning now to the embodiment shown in FIGS. 11 to 15, the configuration of a suspension assembly 40 allowing the cogwheel 144 of the first transmission means of the electric drive means 22 to be moved between a disengaged condition and an engaged condition relative to the rack 124 of the second transmission means, and vice versa, will be described in further detail. In FIG. 11, the position of the cogwheel 144 at the right-hand longitudinal end of the bottom element 14 of the screening arrangement 10 is shown in some detail.

It is to be understood that one suspension assembly 40 is located at each end of the bottom element 14. Only one suspension assembly 40 will be described in detail; the suspension assembly at the other end is substantially a mirror-inverted version of the described suspension assembly 40.

The suspension assembly 40 comprises an inner part 41 provided with the first transmission means, and an outer part 42. The inner part 41 and the outer part 42 are movable relative to each other to allow the cogwheel 144 of the first transmission means to assume an engaged condition in which the cogwheel 144 is in engagement with the rack 124 of the second transmission means and a disengaged condition in which the cogwheel 144 is disengaged from the rack 124.

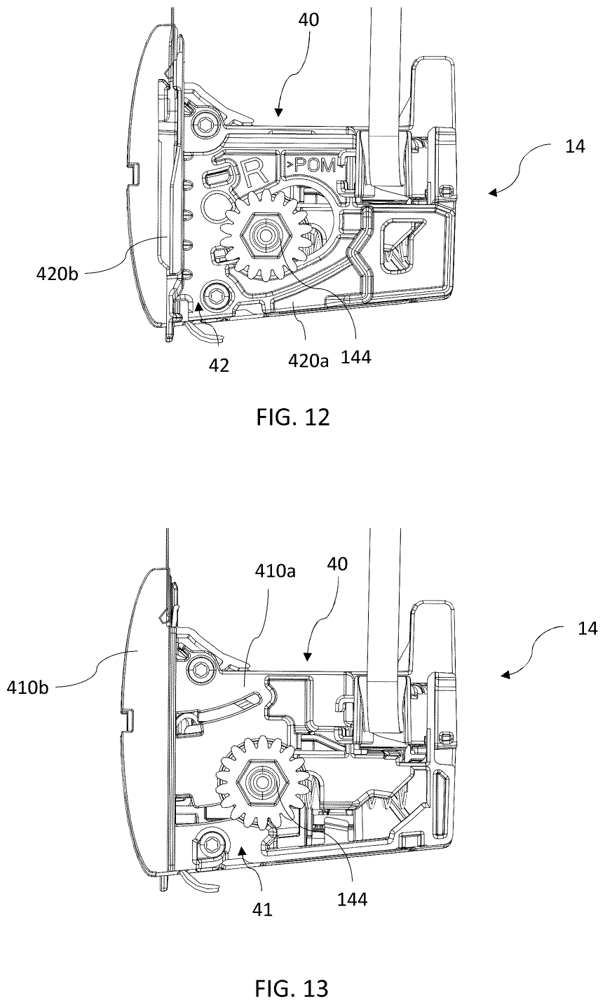

FIG. 12 is a side view of the same parts of the screening arrangement as shown in FIG. 11. FIG. 13 is similar to FIG. 12 except that the outer part 42 is not shown, thus revealing the view onto the inner part 41.

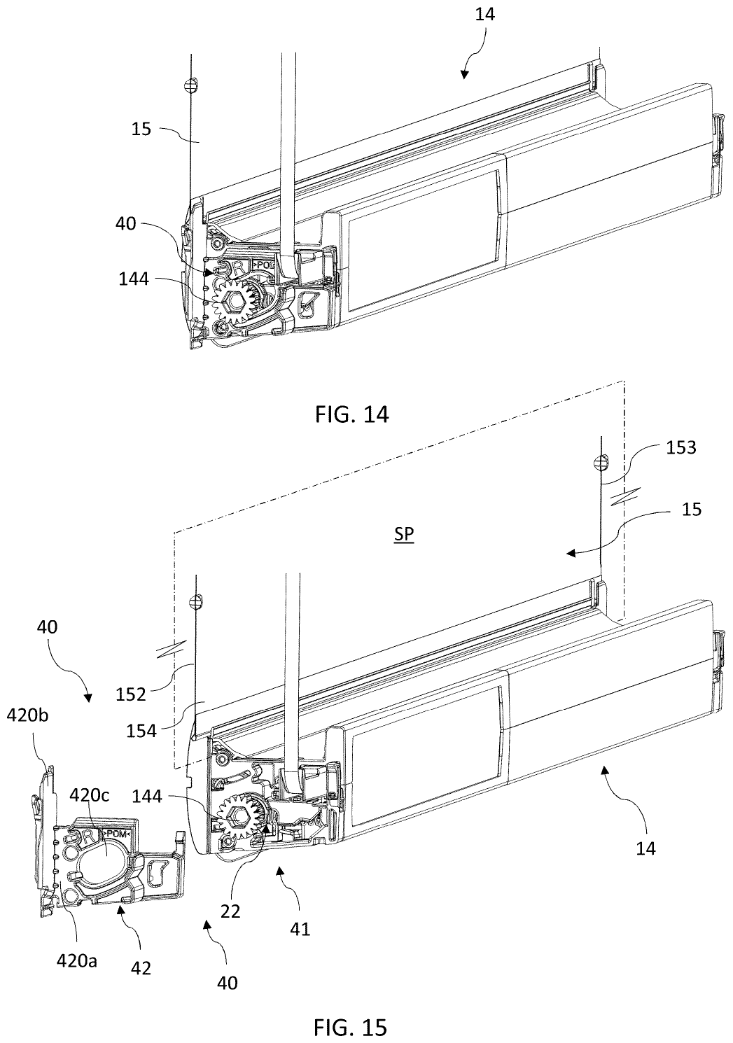

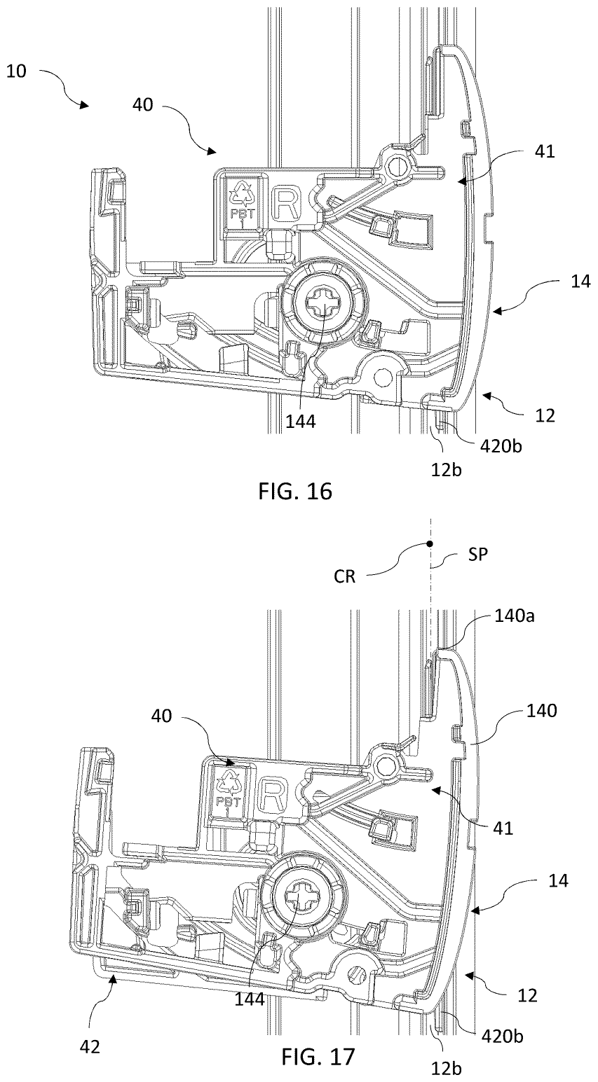

FIG. 14 and FIG. 15 show the interaction between the bottom element 14, the inner part 41 and the outer part 42. The cogwheel 144 is mounted on the rotatable shaft 143 (see FIG. 7) reaching through the inner part 41 and the outer part 42 so as to allow the cogs of the cogwheel 144 to be brought into engagement with the teeth of the rack 124. The shaft 143 is, in a manner known per se, typically connected to a motor accommodated in the bottom element 14. Further elements of the operating means of the electric drive means accommodated in the bottom element 14 may include battery means, for instance the battery means 28 of the embodiment of FIG. 10, and a printed circuit board. The shaft may be throughgoing such that the cogwheel at the opposite end is placed on the same shaft, or two separate shaft portions may be provided. It is noted that FIG. 15 shows the same view on the bottom element 14 and the inner part 41, the difference being that the outer part 42 is removed from the inner part 41. Also shown in these figures are the side edges 152, 153 of the screening body 15, which are guided in a track 12b of the respective side rail 12, 13 (cf. FIGS. 16 and 17), and the screening plane SP substantially coincides with a plane spanned by the tracks in the respective side rail 12, 13. The track 12b extends in the longitudinal direction L. Furthermore, in the embodiment shown the track 12b is defined by the first and second flanges 121, 122 and may provide a light-proof overlap between the screening body 15 and the side rail 12.

Referring now first to the embodiment of FIGS. 16 and 17, the functionality of the suspension assembly 40 placed at each end of the bottom element 14 will be described in detail, i.e. how the inner part 41 and the outer part 42 are movable relative to each other to allow the cogwheel 144 of the first transmission means to assume an engaged condition in which the cogwheel 144 is in engagement with the rack 124 of the second transmission means and a disengaged condition in which the cogwheel 144 is disengaged from the rack 124.

The suspension assembly 40 allows the cogwheel 144 of the first transmission means to perform a substantially part-circular movement about a centre of rotation, CR, located on the screening plane SP, during movement of the inner part 41 relative to the outer part 42 when moving from the engaged condition to the disengaged condition and vice versa.

FIG. 17 shows the centre of rotation CR of the inner part 41 and the cogwheel 144, when rotated in relation to the outer part 42. More specifically, the centre of rotation CR is located at a distance from the top edge 140a of the front 140 of the bottom element 14 as seen in the longitudinal direction L. This is the centre of rotation CR of the movement of the cogwheel 144 when disengaging from engaged condition with the rack 124 shown in FIG. 16 to the disengaged condition shown in FIG. 17.

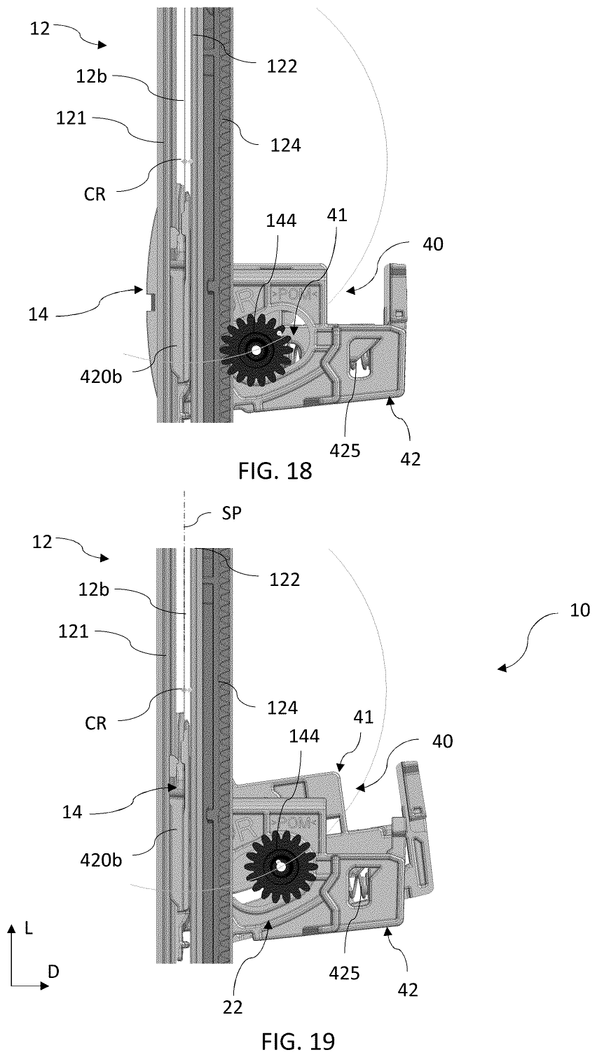

Correspondingly, FIG. 18 shows an embodiment of the screening arrangement 10 with the cogwheel 144 in the engaged condition, as it is interacting with the rack 124. FIG. 19 shows the cogwheel 144 located at a distance from the rack 124, i.e. the cogwheel 144 has travelled a distance in the depth direction D due to the rotation about the centre of rotation CR.

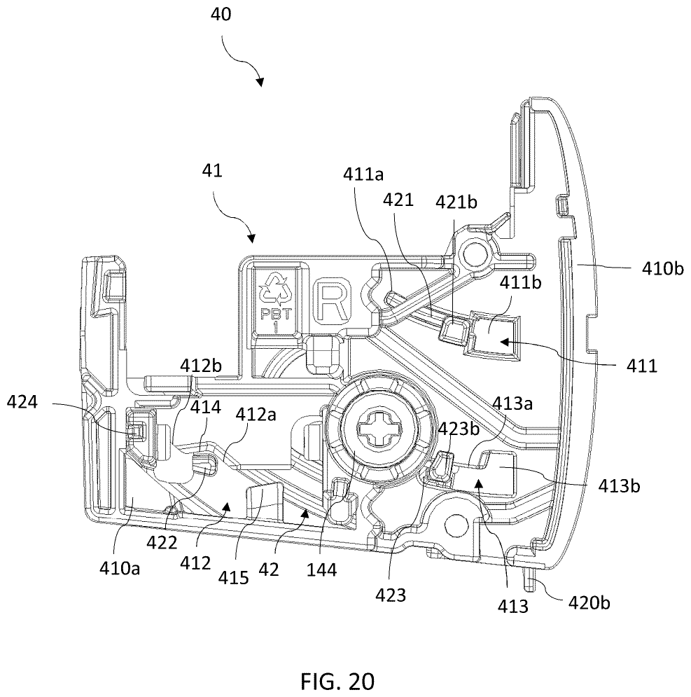

With particular reference to the embodiment shown in FIG. 20, details of the configuration of the suspension assembly 40 will be described: To enable the controlled engagement and disengagement, the inner part 41 and the outer part 42 of the suspension assembly 40 comprise curved engagement means defining a radius of curvature allowing the cogwheel 144 of the first transmission means to perform the substantially part-circular movement about the centre of rotation CR.

Correspondingly to the end portions of the bottom element 14, the inner part 41 of the suspension assembly 40 comprises a substantially plane base portion 410a and a front portion 410b which together match the cross-sectional shape of the main portion of the bottom element 14, such that they can be mounted next to and abutting each other to extend the main body in the width direction.

In order for the components of the screening arrangement to stay in well-defined relations to each other, the outer part 42 of the suspension assembly 40 comprises a base portion 420a and a slide portion 420b interacting with a track 12b in the associated side rail 12 (cf. for instance FIGS. 16 and 17). The slide portion 420b thus connects and aligns the outer part 42 with respect to the side rail 12. Furthermore, the slide portion 420b prevents the bottom element 14 from dislocating in a direction other than the longitudinal direction L. The base portion 420a comprises an oblong opening 420c (FIG. 15) to allow the shaft 143 of the first transmission means to reach through and accommodate movement of the shaft 143 during the rotation of the inner part 41 relative to the outer part 42 as will be illustrate below.

In contrast, the inner part 41 is able to move in a direction other than the longitudinal direction, namely by the curved engagement means of the suspension assembly 40 allowing the rotation about the centre of rotation CR. The curved engagement means are in the embodiment shown provided by at least one curved guide portion, here three guide portions 411a, 412a, 413a, on the inner part 41, specifically in the base portion 410a of the inner part 41, to interact with corresponding protrusions, here first, second and third protrusion 421, 422, 423, on the outer part 42, here provided on the base portion 420a of the outer part 42. The curve of each curved guide portion forms an arc, where the centre of rotation CR is the point that has the same distance to all parts of the individual arc, thus defining the radius of curvature.

In principle, the inner part 41 of the suspension assembly 40 may comprise one curved guide portion, or two or more than three curved guide portions at a mutual distance from each other, and two or more than three protrusions. In case there are multiple curved guide portions, they are configured to allow movement of the inner and the outer part in relation to each other such that the inner part rotates 41 around the centre of rotation CR relative to the outer part 42.

Moreover, in the embodiment shown, the suspension assembly 40 is biased towards the engaged condition in which the inner part 41 and the outer part 42 overlap each other in full, by means of a spring 425 acting on the inner part 41. FIGS. 18 and 19 show the spring 425 in an embodiment of the invention in which the spring 425 is a compression spring, configured to exert a force on the inner part 41. Therefore one end of the spring 425 is arranged on the inner part 41, the other end is held by the outer part 42. Alternatively, the other end may be held by the bottom element 14. In any event, it is preferred that the spring 425 is completely relaxed in the engaged condition such that the structure is substantially unloaded when mounted and in use.

In order to maintain the engagement between the inner and outer parts 41, 42, one or more of the protrusions may comprise a head. Here the first and third protrusions 421, 423 each comprises a head 421b, 423b as shown in FIG. 20, configured to slide on a face of the inner part 41 facing away from the outer part 42 during the movement of the inner part 41 relative to the outer part 42. The heads 421b, 423b form parts that restrict the movement of the inner part 41 in relation to the outer part in the width direction W in an assembled state of the screening arrangement 10.

A further feature shown in FIG. 20 is that the curved guide portions 411a, 412a, 413a form part of a respective track 411, 412, 413 of the inner part 41. In this way, secure guiding of the inner part 41 relative to the outer part 42 is able to take place. In the embodiment shown, each track 411, 413 accommodating a protrusion 421, 423 with a head 421b, 423b comprises an enlarged section 411b, 413b configured to accommodate the head 421b, 423b of the respective first and third protrusion 421, 423 of the outer part 42 of the suspension assembly 40. The enlarged section 411b, 413b provides the head 421b, 423b with an opening to enter onto the opposite side of the inner part 41 during assembly, for the protrusion 421, 423 to be moved into the remaining portion of the track, thereby connecting the inner part 41 and the outer part 42.

Finally, in FIG. 20 is shown a lock protrusion 424 provided on the outer part 42 and which is able to enter the track 412 at an enlarged section thereof, substantially located at an abutment portion 414 of the inner part 41, in the distinct position corresponding to the supply condition of the screening arrangement. The lock protrusion 424 is formed so to reach through the inner part 41, and when reaching through abuts the abutment portion 414 of the inner part 41. In the mounted condition, corresponding to the condition of use shown in FIG. 20, the lock protrusion 424 is located at the left-most position of the track 412. The track 412 is provided with an additional curved guide portion 412b to allow the inner part 41 to be slid along the lock protrusion 424 of the outer part 42.

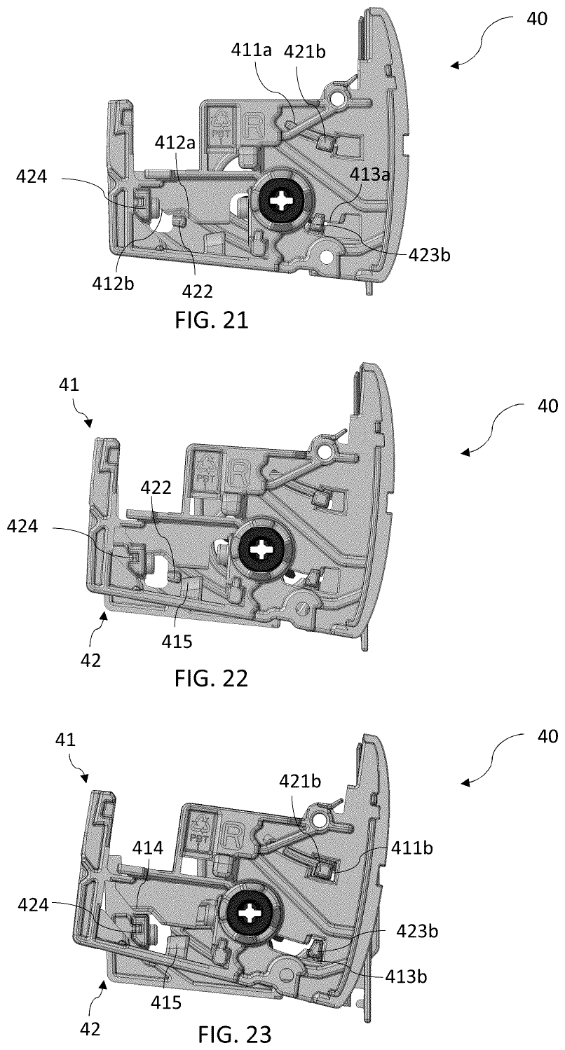

Referring now to FIGS. 21 to 23, the movability of the inner part 41, and hence of the remaining components of the bottom element 14, on the one hand, and the outer part 42 on the other will be described. The position shown in FIG. 21 corresponds to the position of FIG. 20, i.e. corresponding to the engaged condition in which the cogwheels 144 of the first transmission means are in engagement with the racks 124 located in the side rails 12, 13. In this position, the screening arrangement 10 is in its use condition. The inner part 41 overlaps the outer part 42. Other than the position assumed in the engaged condition, the inner part 41 and the outer part 42 of the suspension assembly 40 are able to assume two distinct positions relative to each other in said disengaged condition, shown in FIG. 22 and FIG. 23, respectively.

In FIG. 23, the mutual position of the inner part 41 and the outer part during assembly of the screening arrangement 10 is shown. The inner part 41 has been rotated through a predefined angle, here about 8°, such that the head 421b of the first protrusion 421 is located opposite the enlarged section 411b of the track 411 and the head 423b of the third protrusion 423 is located opposite the enlarged section 413b of the third track 413. The lock protrusion 424 is also able to pass through the associated opening in the inner part 41, while the second protrusion 422 is hidden behind the inner part 41 in the view of FIG. 23. Once the inner parts 41 have been coupled to the respective outer parts 42 at either end, a distinct position corresponding to a supply condition of the screening arrangement 10 has been attained. That is, a condition in which the screening arrangement 10 is supplied and generally not intended to be used. The force of the spring 425 is prevented from applying its bias. In the supply condition, the lock protrusion 424 provided on the outer part 42 is brought into abutment with the abutment portion 414 of the inner part 41. Furthermore, the inner part 41 comprises a receiving portion 415 configured to receive the second protrusion 422 in the supply condition of the screening arrangement. Thus, the inner part 41 and outer part 42 remain in a relative position in which the cogwheel 144 is lifted off the rack 124 provided in the side rail 12, 13, and hereby, mounting of the bottom element 14 to the side rails 12, 13 is facilitated.

FIG. 22 shows the other distinct position in which the transmission means are disengaged as well, but in which the inner part 41 is able to move relative to the outer part 42 and the spring 425 is urging the cogwheel 144 back into the engaged position. While the user may thus rotate the bottom element 14, including the inner parts 41 at either end, the rotating movement is stopped by the second protrusion 422 coming into contact with the receiving portion 415 of the inner part. In the shown embodiment, the rotation is limited to about 4°. The engagement means are now temporarily disengaged, since releasing the bottom element 14 will bring the bottom element 14 including the inner parts 41 back to the position shown in FIG. 21.

During installation, once the top casing 11 and the side rails 12, 13 of the screening device have been connected to frame 2 of the roof window, the bottom element 14 with the inner parts 41 located at the ends is rotated such that the abutment portion 414 of the inner part 41 is moved away from the lock protrusion 424 and the receiving portion 415 out of engagement with the protrusion 422. The inner part 41 now assumes the position shown in FIG. 22 and the spring 425 urges the inner part 41 further such that the position shown in FIG. 21 is assumed and the screening arrangement is ready for operation.

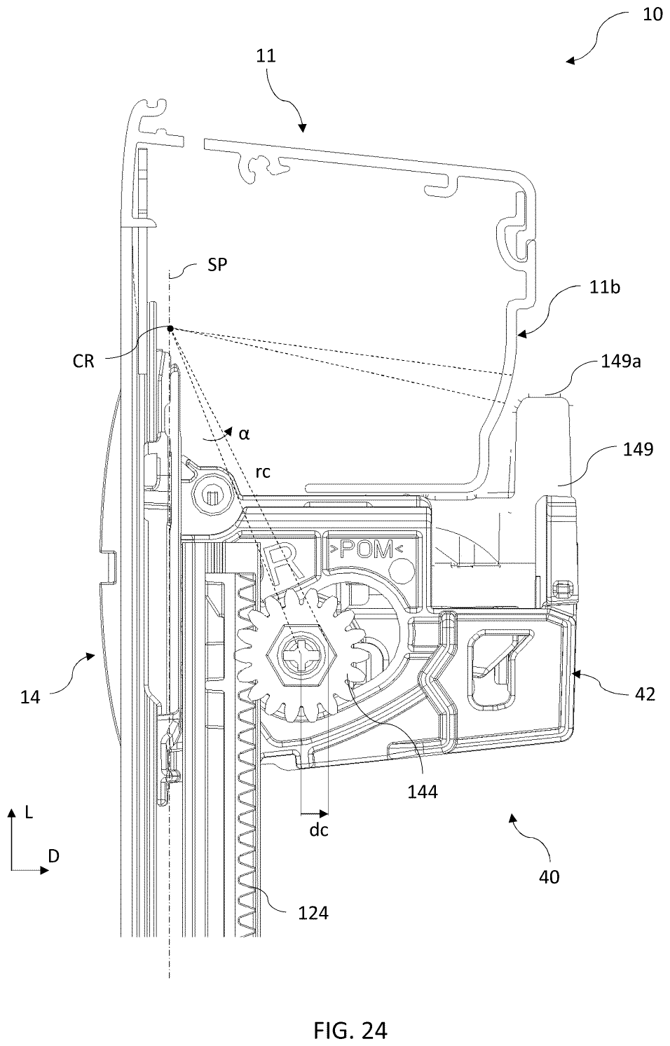

Turning now to FIG. 24, the configuration and dimensioning of the components of the suspension assembly 40 and of other parts of the screening arrangement 10 will be described in some detail. The centre of rotation CR located in the screening plane SP is shown above the bottom element 14 as seen in the longitudinal direction L, together with a representative radius of curvature rc. During the rotation of the suspension assembly 40 performed as described in the above, the cogwheel 144 is allowed to perform the substantially part-circular movement as indicated by angle α to move the cogwheel 144 from the engaged condition shown in FIG. 24 to a disengaged condition in which the teeth of the cogwheel 144 are lifted out of engagement with the teeth of the rack 124.

Selection of suitable values of the radius of curvature rc, the angle α, and the position of the centre of rotation CR is carried out in dependence on factors such as the configuration and dimensions of the top casing 11 and the bottom element 14, and the configuration and dimensions of the respective teeth of the cogwheel 144 and the rack 124.

Typical values for the angle α lie in the interval 2 to 10° and for the radius of curvature rc in the interval 20 to 60 mm. Here, the angle α is about 4° and the radius of curvature about 40 mm. The resulting movement of the cogwheel 144 over a distance dc in the depth direction D lies in the range 1.5 to 5 mm. In the embodiment shown, the rotation through an angle α of about 5° results in a movement of the cogwheel 144 over a distance dc of about 3 mm in the depth direction D, which is sufficient to allow disengagement with the selected configuration and dimensions of the components.

Finally, in FIG. 24 a further feature of the particular positioning of the centre of rotation CR is shown, namely that during rotation of the bottom element 14, the top edge 149a of the back portion 149 stops just short of the second profile 11b of the top casing 11.

Concluding, the screening arrangement 10 is thus configured to be supplied in a supply condition and then brought to a mounted condition by a person performing the installation by a suitable method of mounting. In particular, the screening arrangement 10 is configured to be brought from a supply condition in which the suspension assembly 40 is at first in a position in which the cogwheel 144 of the first transmission means is disengaged from the rack 124 of the second transmission means, to a mounted condition in which the cogwheel 144 is in engagement with the rack 124. The method comprises the steps of:
performing a substantially rotating motion on the inner part 41 relative to the outer part 42 thereby allowing the cogwheel 144 to perform a substantially part-circular movement about the centre of rotation CR located on said screening plane SP.

Thereby the teeth of the cogwheel 144 make contact with the teeth of the rack 124 and the first and second transmission means are in the engaged condition.

During operation of the screening arrangement, the desired screening position and of the non-screening position may be indicated by means of the above-mentioned position indicator, which could have the following functionality in a screening arrangement (10):
the screening arrangement further comprises a position indicator (16) slidably positionable along at least one of the side rails (12) for manually indicating a desired longitudinal position of the bottom element (14), the longitudinal position of said position indicator (16) being manually adjustable by physical movement of the position indicator (16) to an arbitrary longitudinal position along the at least one side rail (12), the position indicator (16) being configured to engage the bottom element (14) by releasable positive engagement means when the bottom element (14) is brought into contact with the position indicator (16) to assume an engaged condition, in such a way that:
i) the positive engagement means is arranged to be released when the longitudinal position of the position indicator (16) is manually adjusted by applying a force on the position indicator substantially in said longitudinal direction (L), and
ii) the positive engagement means is arranged to keep the position indicator (16) in the engaged condition with the bottom element (14) to follow the movement of the bottom element (14) in said longitudinal direction (L) when the bottom element (14) is moved in the longitudinal direction (L) by activation of the electric drive means.

Specific embodiments of the invention have now been described. However, several alternatives are possible, as would be apparent for someone skilled in the art.

Such and other obvious modifications must be considered to be within the scope of the present invention, as it is defined by the appended claims.

### LIST OF REFERENCE NUMERALS

1 roof window
2 frame
   2.1 top member
   2.2 side member
   2.3 side member
   2.4 bottom member
3 window opening
4 pane
10 screening arrangement
11 top casing
   11a first profile
   11b second profile
   113 cover top portion
   114 front rail
   114a top edge of front rail
   114b bottom edge of front rail
   115 cover back portion
   115b bottom edge of cover back portion
12 side rail
   12b track
   121 first flange
   122 second flange
   123 leg
   124 rack
13 side rail
14 bottom element
   14a first profile
   14b second profile
   14c third profile
   140 front of bottom element
   140a top edge of front of bottom element
   141 notch
   143 shaft
   144 cogwheel
   145 upwards facing surface
   149 back portion
   149a top edge of back portion
15 screening body
   151 top portion
   152 side edge
   153 side edge
   154 bottom portion
   154a locking wire
16 position indicator
22 electric drive means
23 roller shaft
25 end piece
   25a electric terminals
27 solar panel
28 battery means
40 suspension assembly
41 inner part
   410a base portion
   410b front portion
   411 track
   411a first curved guide portion
   411b enlarged section
   412 track
   412a second curved guide portion
   412b additional curved guide portion
   413 track
   413a third curved guide portion
   413b enlarged section
   414 abutment portion
   415 receiving portion
42 outer part
   420a base portion
   420b slide portion
   420c oblong opening
   421 first protrusion
   421b head of first protrusion
   422 second protrusion
   423 third protrusion
   423b head of third protrusion
   424 lock protrusion
   425 spring
L longitudinal direction
W width direction
D depth direction
SP screening plane
CR centre of rotation
α angle
rc radius of curvature
dc distance
P1 first plane
P2 second plane
RS receiving space
OR operating space

1. A screening arrangement for a window, said window comprising a frame with a top member, a bottom member and two mutually parallel side members, said screening arrangement comprising:
a screening body having two side edges, a top portion and a bottom portion,
two side rails, each defining a longitudinal direction, a width direction and a depth direction,
a bottom element connected to the bottom portion of the screening body and being configured to be longitudinally positionable in said longitudinal direction between a non-screening position of the screening body and a screening position by means of electric drive means operably connecting the bottom element and the side rails, the screening body defining a screening plane in said screening position substantially parallel to a plane defined by the longitudinal direction and the width direction,
said electric drive means comprising operating means including first transmission means including a cogwheel at each longitudinal end portion of the bottom element and second transmission means including a rack arranged in each of the side rails, and
a suspension assembly being provided at each end of the bottom element, each suspension assembly comprising an inner part provided with said first transmission means, and an outer part, the inner part and the outer part being movable relative to each other to allow the cogwheel of the first transmission means to assume an engaged condition in which the cogwheel is in engagement with the rack of the second transmission means and a disengaged condition in which the cogwheel is disengaged from the rack,
wherein each suspension assembly is configured such that the cogwheel of the first transmission means is allowed to perform a substantially part-circular movement about a centre of rotation located on said screening plane during movement of the inner part relative to the outer part when moving from the engaged condition to the disengaged condition and vice versa.

2. The screening arrangement according to claim 1, wherein the bottom portion of the screening body is connected to the bottom element at or near a top edge of a front of the bottom element, and wherein the centre of rotation is located at a distance from the top edge of the front of the bottom element as seen in the longitudinal direction.

3. The screening arrangement according to claim 1, wherein the inner part and the outer part of each suspension assembly comprise curved engagement means defining a radius of curvature allowing the cogwheel of the first transmission means to perform the substantially part-circular movement about the centre of rotation.

4. The screening arrangement according to claim 1, wherein the bottom element comprises a main portion composed by a set of profiles defining a cross-sectional shape of the bottom element, and two end portions surrounding respective longitudinal ends of the main portion of the bottom element.

5. The screening arrangement according to claim 4, wherein the inner part of each suspension assembly comprises a substantially planar base portion and a front portion which together match the cross-sectional shape of the main portion of the bottom element.

6. The screening arrangement according to claim 1, wherein the outer part of each suspension assembly comprises a base portion and a slide portion interacting with a track in the associated side rail.

7. The screening arrangement according to claim 3, wherein the curved engagement means of each suspension assembly are provided by at least one curved guide portion on the inner part, to interact with at least one corresponding protrusion on the outer part.

8. The screening arrangement according to claim 7, wherein the inner part of each suspension assembly comprises at least two curved guide portions at a mutual distance from each other and at least two protrusions.

9. The screening arrangement according to claim 1, wherein each suspension assembly is biased towards the engaged condition in which the inner part and the outer part-overlap each other.

10. The screening arrangement according to claim 7, wherein the at least one corresponding protrusion comprises a head configured to slide on a face of the inner part facing away from the outer part during the movement of the inner part relative to the outer part.

11. The screening arrangement according to claim 1, wherein the inner part and the outer part of each suspension assembly are able to assume two distinct positions relative to each other in said disengaged condition.

12. The screening arrangement according to claim 11, wherein one of said two distinct positions corresponds to a supply condition of the screening arrangement.

13. The screening arrangement according to claim 10, wherein the at least one curved guide portion includes one or more curved guide portion or portions which form(s) part of a track of the inner part.

14. The screening arrangement according to claim 13, wherein each track accommodating a protrusion with a head comprises an enlarged section configured to accommodate the head of the respective protrusion of the outer part in a distinct position corresponding to the supply condition of the screening arrangement.

15. The screening arrangement according to claim 14, wherein the inner part comprises at least one receiving portion configured to receive a respective protrusion in the distinct position corresponding to the supply condition of the screening arrangement.

16. The screening arrangement according to claim 14, wherein a lock protrusion is provided on the outer part, configured to be brought into abutment with an abutment portion of the inner part in the distinct position corresponding to the supply condition of the screening arrangement.

17. The screening arrangement according to claim 1, wherein each side edge of the screening body is guided in a track of the respective side rail, and wherein the screening plane substantially coincides with a plane spanned by the tracks.

18. The screening arrangement according to claim 1, wherein the screening arrangement comprises a top casing accommodating at least the top portion of the screening body and connected to an upper end of the side rails.

19. The screening arrangement (10) according to claim 1, wherein the electric drive means comprise an electric motor located in the bottom element or in the top casing, and wherein the operating means of the electric drive means accommodated in the bottom element comprise a rotatable shaft connected with the first transmission means, the bottom element being configured to accommodate battery means and a printed circuit board.

20. The screening arrangement according to claim 1, wherein the electric drive means is powered by solar panels and/or mains power, supplemented by battery means.

21. A method of mounting a screening arrangement from a supply condition to a mounted condition, the screening arrangement including a screening body having two side edges, a top portion and a bottom portion, two side rails, a bottom element connected to the bottom portion of the screening body, a rack arranged in each of the two side rails, and a suspension assembly being provided at each end of the bottom element wherein each suspension assembly includes an inner part having a cogwheel and an outer part, the inner part and outer part being movable relative to each other, wherein, in the supply condition, the suspension assembly is in a position in which each cogwheel is disengaged from a corresponding rack and, in the mounted condition, each cogwheel is in engagement with the corresponding rack, comprising the steps of:
performing a rotating motion on the inner part of each suspension assembly relative to the outer part thereby allowing the cogwheel to perform a substantially part-circular movement about a centre of rotation located on a screening plane defined by the screening body in a screening position wherein the centre of rotation is located on the screening plane.
